(19) United States
(12) Patent Application Publication
(10) Pub. No.: US 2019/0371055 A1
(43) Pub. Date: Dec. 5, 2019

(54) 3D MONITORING SERVER USING 3D BIM OBJECT MODEL AND 3D MONITORING SYSTEM COMPRISING IT

(71) Applicant: University of Seoul Industry Cooperation Foundation, Seoul (KR)

(72) Inventor: Hyunjoo KIM, Seoul (KR)

(21) Appl. No.: 16/431,254

(22) Filed: Jun. 4, 2019

(30) Foreign Application Priority Data
Jun. 5, 2018 (KR) 10-2018-0065021

(51) Int. Cl. G06T 17/05; G08B 21/18

(52) U.S. Cl. CPC G06T 17/05; G06T 2200/24; G08B 21/18

(57) ABSTRACT

Disclosed are a three-dimensional (3D) monitoring server using a 3D BIM object model and a 3D monitoring system including the same capable of implementing 3D modeling using BIM information and GIS information and monitoring buildings and peripheral status information of the buildings using 3D modeling. The 3D monitoring server includes a server communication unit for performing a function of interworking with a user terminal through a wired and wireless communication network; a server storage unit for storing GIS data for integrating BIM data for virtually modeling a building, geographical data occupying a spatial position, and attribute data related to the geographical data; and a server controller for controlling to map monitoring information on the building or a peripheral status of a predetermined range including the building received from an external server to the BIM data and the GIS data to transmit the monitoring information to the user terminal.

### CROSS-REFERENCE TO RELATED APPLICATION

This application claims priority to Korean Patent Application No. 10-2018-0065021, filed on Jun. 5, 2018, the disclosure of which is incorporated herein by reference in its entirety.

### BACKGROUND

### Technical Field

The present disclosure relates to a three-dimensional monitoring system, and more particularly, to a three-dimensional monitoring server using a three-dimensional BIM object model and a three-dimensional monitoring system including the same capable of implementing three-dimensional (3D) modeling using building information modeling (BIM) information and geographic information system (GIS) information and monitoring buildings and peripheral status information of the buildings using 3D modeling.

### Description of the Related Art

In recent years, interest in so-called Smart City for forming public functions of major cities in a network using advanced information communication technology (ICT) is growing. The Smart City refers to a future high-tech city capable of accessing to Internet in any time and any place and freely using advanced IT technologies such as a video conference. Because traffic information may be obtained in real time, a moving distance may be reduced, and remote working is available, the Smart City may make not only life of residents convenient, but also reduce carbon dioxide emission.

Such a Smart City is being currently used in about 30 domestic cities of Korea, but there is no example that implements a user interface, especially 3D modeled user interface, and the Smart City of the number of hundreds in the world is being developed, but an example of a user interface considering the user is extremely rare.

Therefore, a user interface is needed to enhance usability of Smart City and to implement modeling that reflects user preferences and needs.

Furthermore, there is required development of a 3D monitoring system that may easily monitor a specific building and peripheral status information of the specific building through a user terminal instead of directly exploring a peripheral status, but there is no research and development on the 3D monitoring system.

### SUMMARY

The present disclosure provides a 3D monitoring server using a 3D BIM object model and a 3D monitoring system including the same capable of implementing 3D modeling using BIM information and GIS information and monitoring a structure and peripheral status information of the structure using 3D modeling.

A three-dimensional (3D) monitoring server according to an embodiment of the present inventive concept includes a server communication unit for performing a function of interworking with a user terminal through a wired and wireless communication network; a server storage unit for storing GIS data for integrating BIM data for virtually modeling a building, geographical data occupying a spatial position, and attribute data related to the geographical data; and a server controller for controlling to map monitoring information on the building or a peripheral status of a predetermined range including the building received from an external server to the BIM data and the GIS data to transmit the monitoring information to the user terminal.

In the 3D monitoring server according to an embodiment of the present inventive concept, the server controller may include a 3D modeling module for performing 3D modeling based on the BIM data and the GIS data; a monitoring information mapping module for mapping the monitoring information received from the external server to the BIM data and the GIS data; and an alarm generation module for generating an alarm signal based on the monitoring information.

In the 3D monitoring server according to an embodiment of the present inventive concept, the external server may be a server that stores power amount information of each building, and the monitoring information mapping module may map a specific color to each building to perform 3D modeling according to a result of comparing a predetermined power amount reference value of each building and the power amount information.

In the 3D monitoring server according to the embodiment of the present inventive concept, when power amount information of a specific building is equal to or less than a minimum reference value as a result of comparison of the power amount information, the alarm generation module may transmit an alarm signal to an external security company server.

In the 3D monitoring server according to the embodiment of the present inventive concept, the external server may be a server for storing rainfall amount information, and the monitoring information mapping module may map the rainfall amount information to the BIM data and the GIS data to perform 3D modeling.

In the 3D monitoring server according to the embodiment of the present inventive concept, the monitoring information mapping module may compare the received rainfall amount information with a predetermined flood warning standard value and map flood occurrence information to the BIM data and the GIS data to perform 3D modeling, if the rainfall amount information is equal to or greater than the flood warning standard value.

In the 3D monitoring server according to the embodiment of the present inventive concept, the external server may be a server for transmitting disaster occurrence information, and the monitoring information mapping module may map the disaster occurrence information to the BIM data and the GIS data to perform 3D modeling.

In the 3D monitoring server according to an embodiment of the present inventive concept, the external server may be a big data server for storing user preference information, and the monitoring information mapping module may map a building corresponding to the user preference information to a specific color to perform 3D modeling.

A user terminal according to the embodiment of the present inventive concept includes a user interface unit for providing a user interface to receive user setting for 3D modeling implementation; a communication unit for receiving BIM data and GIS data corresponding to the user setting; and a 3D modeling unit for performing 3D modeling based on the received BIM data and GIS data.

In the user terminal according to the embodiment of the present inventive concept, the user setting may include at least one of status setting of a specific status, BIM data setting for selecting at least one individual BIM data of the BIM data, GIS data setting for selecting at least one individual GIS data of the GIS data, and data size setting for limiting a size of the BIM data and the GIS data to be received from the server.

In the user terminal according to the embodiment of the present inventive concept, the status setting may include at least one of a CCTV status, a road traffic light display status, a building selection status that limits a specific building, a power amount information display status of a specific building, a rainfall amount information display status of a specific region, a disaster information display status of a specific region, and a user preference information display status.

In the user terminal according to the embodiment of the present inventive concept, the 3D modeling unit may model a specific building, road, and specific object in a specific color according to predetermined color information.

A 3D monitoring system according to an embodiment of the present inventive concept includes a user terminal including a user interface unit for providing a user interface to receive user setting for 3D modeling implementation, a communication unit for receiving BIM data and GIS data corresponding to the user setting, and a 3D modeling unit for performing 3D modeling based on the received BIM data and GIS data; a 3D monitoring server using a 3D BIM object model and including a server communication unit for performing a function of interworking with the user terminal through a wired and wireless communication network; a server storage unit for storing the BIM data and GIS data; and a server controller for controlling to map monitoring information on a building received from an external server or a peripheral status within a predetermined range including the building to the BIM data and the GIS data to transmit the monitoring information to the user terminal; and an external server for transmitting the monitoring information to the 3D monitoring server.

In the 3D monitoring system according to the embodiment of the present inventive concept, the server controller may include a 3D modeling module for performing 3D modeling based on the BIM data and the GIS data; a monitoring information mapping module for mapping monitoring information received from the external server to the BIM data and the GIS data; and an alarm generation module for generating an alarm signal based on the monitoring information.

In the 3D monitoring system according to an embodiment of the present inventive concept, the monitoring information may include at least one of power amount information, rainfall amount information, disaster occurrence information, and user preference information of each building.

Other specific embodiments of various aspects of the present inventive concept are included in the detailed description below.

### BRIEF DESCRIPTION OF THE DRAWINGS

FIG. 1 is a block diagram illustrating a 3D monitoring system using a 3D BIM object model according to an embodiment of the present inventive concept.

FIGS. 2 and 3 are block diagrams illustrating an example of a user interface unit displayed on a user terminal according to an embodiment of the present inventive concept.

FIG. 4 is a block diagram illustrating a server controller of a 3D monitoring server according to an embodiment of the present inventive concept.

FIG. 5 is a diagram illustrating power amount information in a specific building as an example of 3D modeling displayed on a user terminal according to an embodiment of the present inventive concept.

FIG. 6 is a diagram illustrating flood occurrence information in a specific region as an example of 3D modeling displayed on a user terminal according to an embodiment of the present inventive concept.

FIG. 7 is a diagram illustrating disaster occurrence information in a specific region as an example of 3D modeling displayed on a user terminal according to an embodiment of the present inventive concept.

FIG. 8 is a diagram illustrating a CCTV screen of a specific region as an example of 3D modeling displayed on a user terminal according to an embodiment of the present inventive concept.

FIG. 9 is a diagram illustrating a computing device according to an embodiment of the present inventive concept.

### DESCRIPTION OF EXEMPLARY EMBODIMENTS

The present inventive concept may be variously changed and have several embodiments, and is intended to illustrate specific embodiments and describe in detail specific embodiments in a detailed description. It is to be understood, however, that the present inventive concept is not to be limited to the specific embodiments, but includes all modifications, equivalents, and alternatives falling within the spirit and scope of the invention.

Terms used in the present disclosure are used for describing a specific embodiment and do not limit the present invention. Unless the context otherwise clearly indicates, words used in the singular include the plural, the plural includes the singular. Further, in the present inventive concept, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

Further, in the present specification, it is to be understood that when one component is referred to as being “connected to” or “coupled to” another element, it may be connected directly to or coupled directly to another element or be connected to or coupled to another element, having the other element intervening therebetween. On the other hand, in the present specification, it is to be understood that when one element is referred to as being “connected directly to” or “coupled directly to” another element, it may be connected to or coupled to another element without the other element intervening therebetween.

Further, in the present specification, singular forms may be intended to include plural forms unless the context clearly indicates otherwise.

Further, terms used in the present specification are used only in order to describe specific exemplary embodiments rather than limiting the present invention.

In the present specification, the overlapping description of the same components will be omitted.

Spatial information for three-dimensional modeling may be largely divided into indoor spatial information and outdoor spatial information, and the indoor spatial information may be generally represented with BIM data, and the outdoor spatial information may be represented with GIS data.

BIM refers to a process of virtually modeling a facility by planning, design, engineering (structure, facility, and electricity), construction, and further maintenance and disposal in a multi-dimensional virtual space. In particular, the BIM is a concept similar to multi-dimensional virtual design construction (VDC), which enables cutting edge design and the design and construction of eco-friendly energy and low-cost buildings.

BIM may generate numerical data by forming a building in data and represent three-dimensional display effects. Data of a length connecting start and end points of a line, rather than a simple line or plane operation, are generated, and in the plane, an area is formed in data based on a closed plane.

A GIS is a computer system that enables to collect and use hardware, software, and geographic data of a computer designed to effectively collect, store, update, coordinate, analyze, and represent all types of geographically referable information.

The GIS is information system related technology for storing, extracting, managing, and analyzing information by linking geographical information that represents a spatial position for reference of various earth surface information, and non-graphic attribute information that explains and complements a form and function thereof with graphical and database management functions, and is also a comprehensive analysis means that expresses the spatial relationship of a map by adding feature (attribute) information of geographical information. The GIS integrates and processes geographic data occupying a spatial position and attribute data related thereto. The GIS may be very widely used in land information management, facility management, transportation, urban planning and management, environment, weather forecasting, agriculture, disaster and calamity, education, and population prediction fields.

The BIM data used in the present specification may mean all information about a building used for implementing BIM such as a road, a bridge, and a structure, and the GIS data may refer to as information including street light, crosswalk, parking facilities, internet of things (IOT) facilities for measuring air pollution, CCTV, and the like in addition to geographical information such as a typical river and park.

Hereinafter, a three-dimensional monitoring server using a three-dimensional BIM object model according to an embodiment of the present inventive concept and a three-dimensional monitoring system including the same will be described with reference to the drawings.

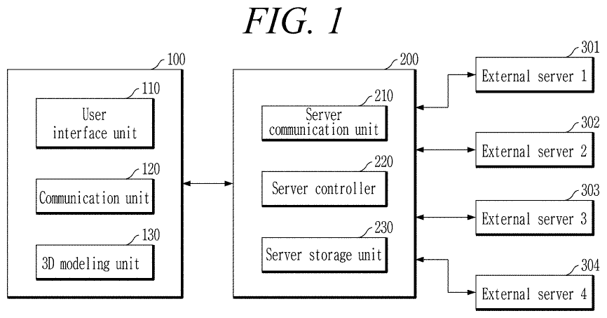

FIG. 1 is a block diagram illustrating a three-dimensional monitoring system using a three-dimensional BIM object model according to an embodiment of the present inventive concept.

As shown in FIG. 1, a three-dimensional monitoring system (hereinafter, referred to as a 3D monitoring system) using a 3D BIM object model according to an embodiment of the present inventive concept may include a user terminal 100, a 3D monitoring server 200, and at least one external server 301 to 304.

The user terminal 100 includes a user interface unit 110, a communication unit 120 and a 3D modeling unit 130 and may be implemented into an electronic device with easy user accessibility such as a mobile phone, a personal computer, a tablet computer, and an image reproduction device having a communication function.

The user interface unit 110 provides various graphic interfaces to a user so as to receive user setting for 3D modeling implementation from the 3D monitoring server 200. Through the graphical interface, the user may input various conditions for the 3D modeling, thereby enabling 3D modeling that meets the user's desired conditions.

That is, according to the present inventive concept, 3D modeling may be performed in various forms according to the user's preference or status rather than the conventional collective and stereoscopic 3D modeling. For example, even if 3D modeling is performed for the entire city, 3D modeling may be implemented using only specific information, for example, an appearance form and an outline of a building or an outline of a road, thereby reducing an amount of data and implementing simplified 3D modeling.

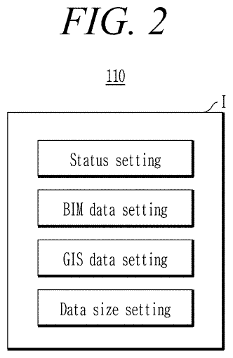

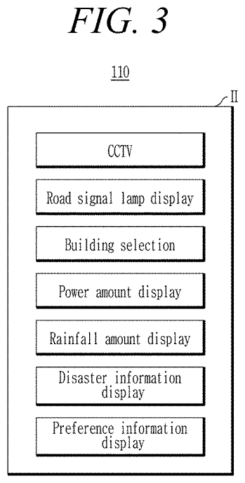

FIGS. 2 and 3 are block diagrams illustrating an example of a user interface unit displayed on a user terminal according to an embodiment of the present inventive concept.

The user may receive various graphic interfaces through the user interface unit 110 of the user terminal 100 and may thus set the graphic interfaces for various options or preferences for 3D modeling.

For example, the user may receive a graphical interface window I of FIG. 2 to perform status setting of a specific status, BIM data setting for selecting at least one individual BIM data among the BIM data, GIS data setting for selecting at least one individual GIS data among GIS data, and data size setting for limiting a size of BIM data and GIS data to be received from the server.

The status setting of a specific status is for a special status in which 3D modeling is required, and when the user selects a graphical interface window I of FIG. 2, a sub-graphical interface window II of FIG. 3 may be provided. As shown in FIG. 3, the user may select, for example, at least one of a CCTV status, a road traffic light display status, a building selection status that limits a specific building, a power amount information display status of a specific building, a rainfall amount information display status of a specific region, disaster information display status of a specific region, and user preference information display status as status setting.

The communication unit 120 transmits information on user setting to the 3D monitoring server 200 while communicating with the 3D monitoring server 200 and receives BIM data and GIS data corresponding to user setting from the 3D monitoring server 200. The communication unit 120 may be implemented into a communication interface capable of performing wired and wireless communication.

The 3D modeling unit 130 performs 3D modeling based on the BIM data and the GIS data. The 3D modeling unit 130 may be implemented into various models, applications, or programs that perform 3D modeling based on object information. For example, the 3D modeling unit 130 may create and share a 3D model similar to Google SketchUp or Google SketchUp in which the user may directly produce a 3D space model in Google Earth and may be implemented into an application such as a Google Building maker that may form a 3D shape of a building to combine the 3D shape with satellite maps. However, it is obvious that the 3D modeling unit 130 is not limited to the above-described Google sketch up or Google building maker, but may be implemented into various modeling tools that typically implement 3D modeling.

Further, the 3D modeling unit 130 may model a specific building or road with a specific color according to predetermined color information. For example, according to the user's selection or previously setting, fire stations may be represented with red, hospitals may be represented with white, or specific distances in frequently visited regions may be highlighted. That is, the 3D modeling unit 130 may model a specific object with a specific color according to predetermined color information. This also corresponds to one aspect of provision of the user interface, which may increase the user's experience index.

The graphical interface windows I and II provided to the user are not limited to those shown in FIGS. 2 and 3, and thus user settings in which the user may select for 3D modeling are also not limited to those described above. These user settings may be accumulated and updated as data.

The 3D monitoring server 200 includes a server communication unit 210, a server controller 220, and a server storage unit 230. The server communication unit 210 is a communication means that performs a function of interlocking with the user terminal 100 and the external servers 301 to 304 through a wired and wireless communication network and performs a function of transmitting and receiving various data. The external servers 301 to 304 will be described later.

The server storage unit 230 stores various data necessary for driving the 3D monitoring server 200. Further, the server storage unit 230 stores BIM data for virtually modeling a structure, geographic data occupying a spatial position, and GIS data for integrating attribute data related to the geographical data. Further, the server storage unit 230 may store user setting contents as data under the control of the server controller 220. Such user information may be utilized in various aspects. For example, before introducing the operation of the actual Smart City, it is possible to variously measure the users characteristics, daily life, viewpoints, or perceptions and accumulate prior information therefrom. The accumulated information may also be used as data to verify whether IOT sensors installed in the building are operating properly.

The server controller 220 provides BIM data and GIS data corresponding to user setting among BIM data and GIS data stored in the server storage unit 230 to the user terminal 100 while controlling overall functions of the 3D monitoring server 200. The server controller 220 may provide only the minimum amount of data corresponding to user setting among a large amount of BIM data and GIS data stored in the server storage unit 230 to the user terminal 100. This greatly reduces a data volume while implementing 3D modeling of the entire city, thereby enabling faster and more immediate 3D modeling as well as saving resources.

The server controller 220 controls to map information received from the external servers 301 to 304 to BIM data and GIS data and to transmit the mapped information to the user terminal 100. Further, the server controller 220 generates an alarm using information received from the external servers 301 to 304 and transmits the generated alarm to the user terminal 100 or the external servers 301 to 304.

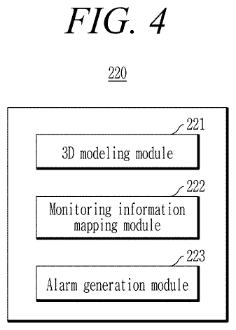

For this, the server controller 220 includes a 3D modeling module 221, a monitoring information mapping module 222, and an alarm generation module 223, as illustrated in FIG. 4.

The 3D modeling module 221 performs 3D modeling based on the BIM data and the GIS data, similar to the 3D modeling unit 130 of the user terminal 100. The 3D modeling module 221 may be implemented into various models, applications, or programs that perform 3D modeling based on object information. For example, the 3D modeling module 221 may create and share 3D models similar to Google SketchUp or Google SketchUp, which enables users to directly create 3D spatial models in Google Earth and may be implemented into applications such as a Google Building maker that may form a 3D shape of a building and combine the 3D shape with satellite maps. However, it is obvious that the 3D modeling module 221 is not limited to the above-described Google SketchUp or Google building maker but may be implemented into various modeling tools that typically implement 3D modeling.

That is, the 3D monitoring server 200 may perform 3D modeling based on the BIM data and the GIS data and transmit the 3D modeling data to the user terminal 100 or the 3D monitoring server 200 may transmit the BIM data and the GIS data to the user terminal 100, and the 3D modeling unit 130 of the user terminal 100 may perform 3D modeling based on the BIM data and the GIS data.

The monitoring information mapping module 222 maps monitoring information received from the external servers 301 to 304 to 3D modeling. Here, the external servers 301 to 304 are servers provided in an external organization. For example, the external server 301 may be a server related to measurement and supply control of a power amount provided by Korea Electric Power Corporation (KEPCO). Further, the external server 302 may be a server provided in an administrative organization and may be a server that stores information related to a rainfall amount provided in a weather station or a server provided in an administrative organization that handles a disaster status such as flood, fire, ground collapse, or accident spot. Although the external server 302 is shown as a single server in the drawing, the external server 302 does not necessarily mean a single server, but means a plurality of servers provided in a plurality of administrative organizations, and the external server 302 may be provided in a physically separated space. The external server 303 may be a server provided in a private institution, for example, a server provided in a security company. The external server 304 may be a big data server.

When the 3D monitoring server 200 receives power amount information from the server 301 of the KEPCO through the server communication unit 210, the monitoring information mapping module 222 maps the power amount information to the BIM data and the GIS data to display the mapped power amount information in a 3D modeling object building.

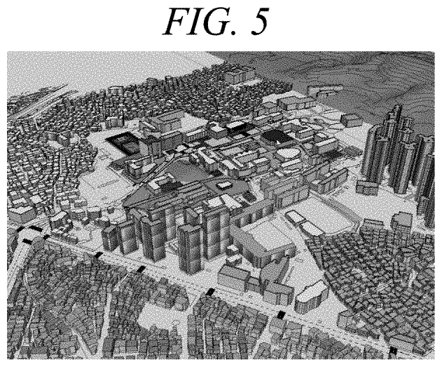

As shown in FIG. 5, the monitoring information mapping module 222 compares a predetermined power amount reference value for each object building with power amount information received from the server 301 of the KEPCO, and when a use power amount of a specific object building is excessive, the monitoring information mapping module 222 may map and display a specific color (e.g., red) to the corresponding building. Conversely, when a use power amount of a specific object building is small, the monitoring information mapping module 222 may map and display a pink color.

Further, when a use power amount of a specific object building is excessive, the monitoring information mapping module 222 may transmit information thereof to the alarm generation module 223, and the alarm generation module 223 may generate an alarm signal notifying that the used power amount is excessive and transmit the alarm signal to a management server (or management office) of the corresponding building connected to wired and wireless communication.

In this case, when a use power amount of a specific building is equal to or less than a minimum reference value, the monitoring information mapping module 222 transmits the information to the alarm generation module 223, and the alarm generation module 223 transmits an alarm signal to the external security company server 303. The security company, having received the alarm signal may start a guard work for the building. Here, a power amount of a minimum reference value means a minimum power amount necessary for maintenance of the building when there is no person in the building. In the case where a final leaving office worker turned off all electric devices such as a lamp in the building and then left but did not lock a door, the 3D monitoring server 200 may notify the external security company of this to strengthen building security. In case of a power amount of the minimum reference value or less regardless of whether a door is actually locked, the 3D monitoring server 200 may notify the security company server of this to enable to perform doubly building security.

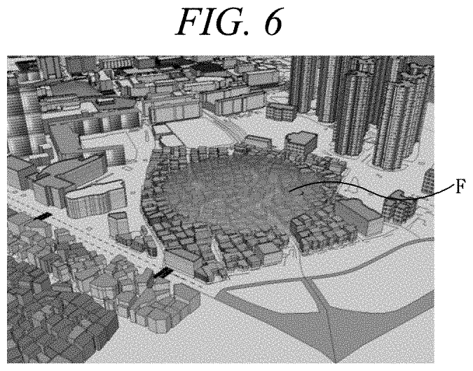

When the 3D monitoring server 200 receives rainfall amount information from the server 302 of the weather station through the server communication unit 210, the monitoring information mapping module 222 maps the rainfall amount information to the BIM data and the GIS data and displays the mapped rainfall amount information in a predetermined range including a 3D modeling object building. In this case, the monitoring information mapping module 222 compares the received rainfall amount information with a predetermined flood warning standard value, and if the rainfall amount information is equal to or higher than the flood warning standard value, the monitoring information mapping module 222 may map and display flood information F to the corresponding region, as shown in FIG. 6 and transmits information on flood occurrence to the alarm generation module 223. The alarm generation module 223 may generate a flood alarm signal and transmit the flood alarm signal to an external flood management institution or to the user terminal 100 connected to wired and wireless communication.

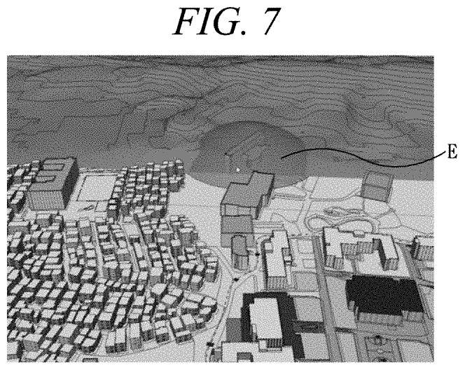

When the 3D monitoring server 200 receives disaster occurrence information such as fire, ground collapse, and an accident from the server 302 of a disaster processing office through the server communication unit 210, the monitoring information mapping module 222 may map and display disaster occurrence information (E, ground collapse status simulation) of the corresponding region to BIM data and GIS data, as shown in FIG. 7. In this case, the monitoring information mapping module 222 may transfer the received disaster occurrence information to the alarm generation module 223, and the alarm generation module 223 may generate a disaster occurrence alarm signal and transmit the disaster occurrence alarm signal to the user terminal 100 connected by wired and wireless communication.

When the 3D monitoring server 200 receives user preference information from the big data server 304 through the server communication unit 210, the monitoring information mapping module 222 may map and display a building related to user preference information received in the corresponding region to a specific color. Here, a keyword, a search word, and a related search word input by the user through various portal sites, and a site address to which the user is connected may be collected in the big data server 304, and user preference information may be extracted and stored through the collected information. The big data server 304 determines user identity from a login ID and an e-mail address input by the user, collects a keyword, a search word, a related search word, and a website address input by the user for each user, processes the keyword, the search word, the related search word, and the website address as user preference information, and stores the keyword, the search word, the related search word, and the website address in the DB.

When a 3D modeling request is received from the user terminal 100 whose user identity has been determined, the 3D monitoring server 200 may receive user preference information from the big data server 304 while providing BIM data and GIS data corresponding to the request and map and provide buildings corresponding to the received user preference information to specific colors such as blue.

For example, when the user preference information is ‘shoe’, by mapping a building such as a shoe store and a general shopping mall existing in a 3D modeling target region to be highlighted in blue, the user may intuitively recognize a building related to the user's preference information and hobby.

The user may select a power amount information display status of the above-described specific building, a rainfall amount information display status of a specific region, a disaster information display status of the specific region, and a user preference information display status from the user interface unit of FIG. 3.

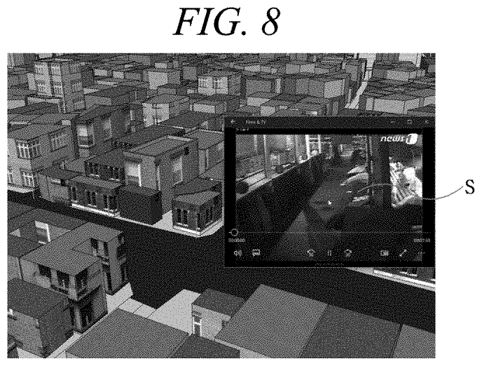

When the user selects a CCTV status, the user may directly view a CCTV screen S at a desired point in the user terminal 100 after 3D modeling of a specific region, as shown in FIG. 8. Through such direct access, the user may view the CCTV screen that may view only in an existing control room or situation room at any place and any time.

Alternatively, by selecting a display state of a road signal lamp, the user may determine a direction of travel and also determine whether an entire road signal lamp is defective. Further, the user may receive information of the terminal about a road status attached to the road signal lamp. For example, the user may grasp a traffic volume of a specific road or the number of pedestrians. An intelligent CCTV may be used for determining the traffic volume or the number of pedestrians. Conventionally, only a high-resolution (4K), a super low light camera, or the like is used for displaying images taken by a camera, but in the present inventive concept, the demand and type of a traffic vehicle may be automatically detected using a real-time image. The present inventive concept may set a specific region to detect and count the number of vehicles passing through the specific region, the kind of vehicles, and passage to a forward or reverse direction or may count the number of pedestrians passing through the specific region.

Further, by selecting only a specific building, for example, a specific building such as a fire station or a hospital as an object, the user may perform 3D modeling. In this case, because only geographical information on a desired building of the user is required for 3D modeling, the user may view more quickly the 3D modeled city.

Alternatively, the user may select at least one individual BIM data of vast BIM data stored in the 3D monitoring server 200 or may select at least one individual GIS data of the GIS data. For example, by selecting only an outline form of a building with individual BIM data or only a specific terrain or road such as a mountain or a river with individual GIS data, the user may perform 3D modeling.

Further, the user may limit an amount of data transmitted from the 3D monitoring server 200 while performing 3D modeling as in conventional case. When data size setting is requested from the user terminal 100, the 3D monitoring server 200 may transmit only minimum data for making into graphic among the BIM data and the GIS data or may select only main data and provide the main data to the user terminal 100.

Through such user setting, because a large amount of data may be reduced from data required for 3D modeling, a speed of communication increases, and the user may view the substantial desired 3D modeling result more quickly.

When the user sets various statuses or options, as in the above example, the server controller 220 of the 3D monitoring server 200 may store the user setting in the server storage unit 230 as a database. When such a database is accumulated, the 3D monitoring server 200 may categorize BIM data and GIS data necessary for 3D modeling and provide more actively and promptly data corresponding to a user request.

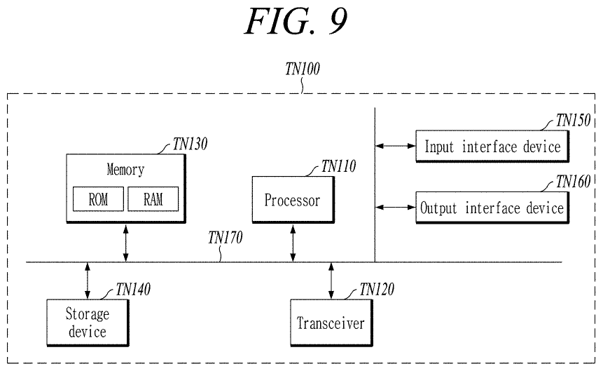

FIG. 9 is a diagram illustrating a computing device according to an embodiment of the present inventive concept. A computing device TN100 of FIG. 9 may be a device (e.g., a 3D monitoring server, a user terminal, a device for a 3D monitoring system, etc.) described in the present specification.

In the embodiment of FIG. 9, the computing device TN100 may include at least one processor TN 110, a transceiver TN 120, and a memory TN 130. Further, the computing device TN100 may further include a storage device TN140, an input interface device TN150, and an output interface device TN160. Components included in the computing device TN100 may be connected by a bus TN170 and communicate with each other.

The processor TN110 may execute a program command stored in at least one of the memory TN130 and the storage device TN140. The processor TN110 may mean a central processing unit (CPU), a graphics processing unit (GPU), or a dedicated processor on which methods according to embodiments of the present inventive concept are performed. The processor TN110 may be configured to implement procedures, functions, methods, and the like described in connection with the embodiments of the present inventive concept. The processor TN110 may control each component of the computing device TN100.

Each of the memory TN130 and the storage device TN140 may store various information related to an operation of the processor TN110. Each of the memory TN130 and the storage device TN140 may be configured with at least one of a volatile storage medium and a non-volatile storage medium. For example, the memory TN130 may be configured with at least one of a read only memory (ROM) and a random access memory (RAM).

The transceiver (transmitting and receiving device) TN120 may transmit or receive a wired signal or a wireless signal. The transceiver TN120 may be connected to a network to perform communication.

The exemplary embodiments of the present inventive concept are not implemented only by the apparatus and/or method as described above, but may be implemented by programs realizing the functions corresponding to the configuration of the exemplary embodiments of the present inventive concept or a recording medium recorded with the programs, which may be readily implemented by a person having ordinary skill in the art to which the present inventive concept pertains from the description of the foregoing exemplary embodiments.

While embodiments of the present inventive concept have been described, it will be understood by those skilled in the art that various modifications and changes may be made by addition, change, or deletion without departing from the spirit and scope of the invention as defined by the appended claims and it is also within the scope of the invention.

What is claimed is:

1. A three-dimensional (3D) monitoring server using a 3D BIM object model, comprising:
a server communication unit for performing a function of interworking with a user terminal through a wired and wireless communication network;
a server storage unit for storing GIS data for integrating BIM data for virtually modeling a building, geographical data occupying a spatial position, and attribute data related to the geographical data; and
a server controller for controlling to map monitoring information on the building or a peripheral status of a predetermined range comprising the building received from an external server to the BIM data and the GIS data to transmit the monitoring information to the user terminal.

2. The 3D monitoring server of claim 1, wherein the server controller comprises:
a 3D modeling module for performing 3D modeling based on the BIM data and the GIS data;
a monitoring information mapping module for mapping the monitoring information received from the external server to the BIM data and the GIS data; and
an alarm generation module for generating an alarm signal based on the monitoring information.

3. The 3D monitoring server of claim 2, wherein the external server is a server that stores power amount information of each building, and
wherein the monitoring information mapping module is a 3D monitoring module that maps a specific color to each building to perform 3D modeling according to a result of comparing a predetermined power amount reference value of each building and the power amount information.

4. The 3D monitoring server of claim 3, wherein the alarm generation module transmits an alarm signal to an external security company server when power amount information of a specific building is equal to or less than a minimum reference value as a result of comparison of the power amount information.

5. The 3D monitoring server of claim 2, wherein the external server is a server for storing rainfall amount information, and
wherein the monitoring information mapping module maps the rainfall amount information to the BIM data and the GIS data to perform 3D modeling.

6. The 3D monitoring server of claim 5, wherein the monitoring information mapping module compares the received rainfall amount information with a predetermined flood warning standard value and maps flood occurrence information to the BIM data and the GIS data to perform 3D modeling, if the rainfall amount information is equal to or greater than the flood warning standard value.

7. The 3D monitoring server of claim 2, wherein the external server is a server for transmitting disaster occurrence information, and
wherein the monitoring information mapping module maps the disaster occurrence information to the BIM data and the GIS data to perform 3D modeling.

8. The 3D monitoring server of claim 2, wherein the external server is a big data server for storing user preference information, and
wherein the monitoring information mapping module maps a building corresponding to the user preference information to a specific color to perform 3D modeling.

9. A user terminal, comprising:
a user interface unit for providing a user interface to receive user setting for 3D modeling implementation;
a communication unit for receiving BIM data and GIS data corresponding to the user setting; and
a 3D modeling unit for performing 3D modeling based on the received BIM data and GIS data.

10. The user terminal of claim 9, wherein the user setting comprises at least one of status setting of a specific status, BIM data setting for selecting at least one individual BIM data of the BIM data, GIS data setting for selecting at least one individual GIS data of the GIS data, and data size setting for limiting a size of the BIM data and the GIS data to be received from the server.

11. The user terminal of claim 10, wherein the status setting comprises at least one of a CCTV status, a road traffic light display status, a building selection status that limits a specific building, a power amount information display status of a specific building, a rainfall amount information display status of a specific region, a disaster information display status of a specific region, and a user preference information display status.

12. The user terminal of claim 11, wherein the 3D modeling unit models a specific building, road, and specific object in a specific color according to predetermined color information.

13. A 3D monitoring system, comprising:
a user terminal comprising a user interface unit for providing a user interface to receive user setting for 3D modeling implementation, a communication unit for receiving BIM data and GIS data corresponding to the user setting, and a 3D modeling unit for performing 3D modeling based on the received BIM data and GIS data;
a 3D monitoring server using a 3D BIM object model and comprising a server communication unit for performing a function of interworking with the user terminal through a wired and wireless communication network; a server storage unit for storing the BIM data and GIS data; and a server controller for controlling to map monitoring information on a building received from an external server or a peripheral status within a predetermined range including the building to the BIM data and the GIS data to transmit the monitoring information to the user terminal; and
an external server for transmitting the monitoring information to the 3D monitoring server.

14. The 3D monitoring system of claim 13, wherein the server controller comprises:
a 3D modeling module for performing 3D modeling based on the BIM data and the GIS data;
a monitoring information mapping module for mapping monitoring information received from the external server to the BIM data and the GIS data; and
an alarm generation module for generating an alarm signal based on the monitoring information.

15. The 3D monitoring system of claim 13, wherein the monitoring information comprises at least one of power amount information, rainfall amount information, disaster occurrence information, and user preference information of each building.
